(19) United States
(12) Patent Application Publication
(10) Pub. No.: US 2014/0265885 A1
(43) Pub. Date: Sep. 18, 2014

(54) MULTIPLE POWER OUTPUTS GENERATED FROM A SINGLE CURRENT SOURCE

(71) Applicant: CREE, INC., DURHAM, NC (US)

(72) Inventors: QINGCONG HU, MORRISVILLE, NC (US); MATT REYNOLDS, CHAPEL HILLS, NC (US)

(73) Assignee: CREE, INC., DURHAM, NC (US)

(21) Appl. No.: 13/795,380

(22) Filed: Mar. 12, 2013

(51) Int. Cl. H05B 37/02

(52) U.S. Cl. CPC H05B 37/02
USPC 315/186; 307/31

(57) ABSTRACT

A system includes a power converter that is configured to supply current to a plurality of output loads connected in series. At least one of the output loads is connected in parallel with a switch that switches in accordance with a duty cycle. The duty cycle may be set in accordance with a predetermined current ratio of average current flow through the output loads.

### TECHNICAL FIELD

The present disclosure relates generally to power converters, and more particularly to the generation of multiple power outputs from a single power current source.

### BACKGROUND

Power converters may be used to convert a direct current (DC) or a rectified alternating current (AC) input voltage to a DC output voltage. Multiple power converters may be used to generate multiple DC output voltages to power multiple output loads, which may result in high cost. Multiple output voltages may be generated in parallel using a single power converter. However, output circuitries generating the output voltages may block the highest of the output voltage, even though some of the output voltages are relatively low.

### BRIEF DESCRIPTION OF THE DRAWINGS

FIG. 1 shows a schematic diagram of an example system that includes a single current source.

FIG. 2 shows a schematic diagram of an example power converter system.

FIG. 3 shows a schematic diagram of another example power converter system that includes a plurality of light emitting diodes.

FIG. 4 shows a block diagram of an example lighting system.

FIG. 5 shows a flow diagram of an example method of conducting current through a plurality of output loads.

### DETAILED DESCRIPTION

The present disclosure describes systems that control electrical current from a single current source through multiple output loads that may be connected series. The systems may include a power converter that supplies the current to the output loads. The systems may also include a controller that controls the flow of current through the output loads. Bypass paths including switches may be included around or in parallel with one or more of the output loads. The controller may communicate with the switches to control whether the current flows through the output loads or through the bypass paths. By controlling the current flow through the output loads and the bypass paths, current ratios of the currents flowing through the output loads may be controlled.

FIG. 1 shows a circuit diagram of an example circuit 100 that is configured to supply electrical current to multiple output loads connected in series. The circuit 100 may include a current source 102 in electrical communication with and configured to supply electrical current to output circuitry 103. The current source 102 may be a single current source and that may include a circuit element or a combination of circuit elements that generates and supplies an alternating current (AC) or a direct current (DC) to the circuit segments 104a to 104n. In one example configuration, the current source 102 may be a power converter, as described in more detail below, although other current sources may be used, such as a photovoltaic panel configured to supply an output current.

The output circuitry 103 may include an n-number of circuit segments 104a to 104n connected in series. There may be at least two circuit segments 104, such as circuit segment 104a and 104b, although other numbers of circuit segments 104 may be included. Each of the circuit segments 104a to 104n may include an output load Z1 to Zn, respectively, from which an output signal Vₒᵤₜ may be measured. For example, the first circuit segment 104a may include a load Z1, and an output voltage Vₒᵤₜ₁ may be measured across Z1; the second circuit segment 104b may include a load Z2, and an output voltage Vₒᵤₜ₂ may be measured across Z2; and the nth circuit segment 104n may include a load Zn, and an output voltage Vₒᵤₜₙ may be measured across Zn.

Each of the output loads Z1 to Zn may be an electronic device and/or electronic component or plurality of electronic devices and/or electronic components from which an output may be obtained, produced or generated, and/or that may output an output signal. The output loads Z1 to Zn may be active devices, passive devices, or combinations thereof. In addition or alternatively, the output loads Z1 to Zn may be configured to conduct current, maintain a substantially constant voltage at an input terminal of the load, and/or function as a current sink. In addition or alternatively, the output loads Z1 to Zn may be configured to generate energy and/or emit heat. Non-limiting examples include one or more solid state light emitters such as light emitting diodes (“LEDs”), cooling systems, motors, gear units, resistive and/or inductive actuators, zener diodes, linear circuitry, pulse-width-modulated (PWM) converters, resistors, capacitors, inductors, various other types of diodes, or any combination thereof. Various other types of output loads Z1 to Zn are possible.

In addition or alternatively, each of the output loads Z1 to Zn may include a single electronic component or circuit element, or a plurality of electronic components or circuit elements. The plurality of electronic components or circuit elements may be connected in series, in parallel, or a combination thereof. As an example illustration, an output load may include a single LED or a plurality of LEDs. The plurality of LEDs may be connected in series, in parallel, or a combination of serial and parallel connections. Various configurations are possible.

The circuit segments 104a-104n may each further include capacitors C1-Cn connected in parallel with the output loads Z1-Zn, respectively. As current flows into a circuit segment 104, the current may split between the capacitor C and the load Z. The proportion of the current that passes through the load Z and the proportion of the current that passes through the capacitor C may depend on the voltage across the capacitor C and/or the amount of available current being supplied from the current source 102. Where the amount of current flowing into the circuit segment 104 is more than an amount of current that the load Z of the circuit segment 104 can handle, then a portion of the current may flow into the capacitor C of the circuit segment 104 and charge the capacitor C. Alternatively, where the amount of current flowing into the circuit segment 104 is less than the amount of current that the load Z can handle, then all of the current flowing into the circuit segment 104 may flow through the load Z. Additionally, where the load Z has capacity to conduct more current than the current flowing into the circuit segment 104, the charge stored in the capacitor C may discharge from the capacitor C and flow into the load Z.

In addition, at least one of the circuit segments 104a-104n may include a bypass circuit path 106 that is connected in parallel with an associated parallel combination of an output load Z and a capacitor C. The bypass path 106 may include a switch Q that is configured to switch between a first state and a second state, or between modes or regions of operation. In the first state, which may be considered an “on” state, the switch Q may exhibit a relatively low amount of resistance and/or function as a short circuit compared to the output load Z, and the current, or a substantial amount of the current, flowing into the circuit segment 104 may flow through the bypass path 106, and not flow through the associated parallel combination of the output load Z and the capacitor C. In the first state, the switch Q may be identified as operating in a first mode or region of operation, such as an active mode or conduction mode. Alternatively, when the switch Q is in the second state, which may be considered an “off” state, the switch may exhibit a relatively high amount of resistance and/or function as an open circuit compared to the parallel combination of the output load Z and the capacitor C, and current flowing into a circuit segment 104 may flow into the parallel combination of the output load Z and the capacitor C of the circuit segment 104, and not through the bypass path 106. In the second state, the switch Q may be identified as operating in a second mode or region of operation, such as an inactive or cutoff mode.

The switch Q may be of various types. For some example configurations, the switch Q may include one or more transistors, such as bipolar junction transistors (BJTs) or field-effect transistors (FETs) (e.g., metal-oxide-semiconductor FETs (MOSFET)), as examples. Other types of transistors may be used. Where transistors are used for the switches Q, the states or modes may be identified with reference to bias voltages or voltage levels being applied to a terminal (e.g., a base terminal or a gate terminal) of the transistor to conduct or not conduct current through the bypass circuit path 106.

In the example circuit 100 shown in FIG. 1, at least one of the circuit segments 104 may not include a bypass circuit path 106. For example, the circuit segment 104a does not include a bypass circuit path. Without a bypass circuit path, all or substantially all of the current supplied by the current source 102 may flow through the parallel combination of the output load Z1 and the capacitor C1. As such, the average or total current through the load Z1 may be equal or substantially equal to the current supplied by the current source 102.

In some example configurations of the circuit 100, only one of the circuit segments 104, such as the circuit segment 104a, does not include a bypass path 106, and all of the remaining circuit segments 104, such as the circuit segments 104b to 104n, may each include a bypass path 106b to 106n. In alternative example configurations, more than one of the circuit segments 104 may not include a bypass circuit path 106. In still other example alternative configurations, all of the circuit segments 104 may include a bypass circuit path 106. However, the number of circuit segments 104 that include or not include a bypass circuit path 106 may depend on characteristics, properties, specifications, and/or requirements of the circuit 100, such as output voltage requirements or the types of the circuit components comprising the output loads Z1 to Zn, as examples. As an illustration, the example circuit 100 may be used for step-up or boost voltage conversion, where the output voltage is greater than an input voltage. To achieve a stepped-up output voltage, the average current through at least one of the output loads Z may be equal or substantially equal to the current supplied by the current source 102 for the circuit 100. As such, it may be undesirable to include a bypass circuit path 106 for all of the circuit segments 104 for some applications.

The switches Q may be configured to switch between the first (“on”) and second (“off”) states by receiving switching signals. The switching signals may comprise one or more characteristics that determine whether the switch is turned “on” or turned “off” and/or for how long the switch is “on” or “off.” Example characteristics include waveform, amplitude, frequency, period, pulse width and/or duty cycle. The duty cycle may determine how long a switch Q is “on” over a period of the switching signal. For example, a duty cycle of fifty percent (50%) may indicate that the switch is “on” for 50% or half of the switching cycle period and consequently “off” for the other 50% of the switching cycle period. In one example, the switching signals may comprise pulse-width modulated (PWM) signals having an associated duty cycle, although other types of switching signals may be used.

For circuit segments 104 that include a bypass circuit path 106, the duty cycle of a switching signal applied to the switch Q may determine the proportion of the current flowing into the circuit segment 104 that flows through the output load Z and capacitor C parallel combination and the proportion that flows through the bypass circuit path 106. For example, if a switching signal having a duty cycle of 50% is applied to the switch Q₂, for current flowing into the circuit segment 102b, about half of the current will flow through the output load Z2 and capacitor C2 parallel combination, and about half of the current will be bypassed around the load output Z2 and the capacitor C2 and flow through the bypass circuit path 106b. Alternatively, if the duty cycle were lower than 50%, such as 30%, then about 70% of the current would flow through the parallel combination of the output load Z2 and the capacitor C2, and about 30% would flow through the bypass circuit path 106b. As such, the amount of current, including the amount of average or total current, flowing through the output loads Z may be set, controlled, managed, and/or adjusted by setting, controlling, managing, and/or adjusting the duty cycles of the switching signals being applied to the switches Q.

Current ratios of the average current flowing through the output loads Z may also be determined by the duty cycles of the switching signals applied to the switches Q. For example, if a switching signal having a 50% duty cycle is applied to the switch Q₂, then the current ratio of the average current flowing through the output load Z1 to the average current flowing through the output load Z2 may be about 2-to-1 because the average current flowing through the output load Z1 is about equal to the average current supplied by the current source 102, whereas the average current flowing through the output load Z2 is about half of the average current supplied by the current source 102. Accordingly, setting, controlling, managing, and/or adjusting the duty cycles, may in turn set, control, manage, and/or adjust the current ratios.

As shown in FIG. 1, for circuit segments 104 that include bypass circuit paths 106, the circuit segments 104 may each further include a reverse blocking diode D connected in series with the parallel combination of the output load Z and the capacitor C. The reverse blocking diode D may be included to maintain the output voltage Vₒᵤₜ across the output load Z and prevent charge stored in the capacitor C from being discharged through the switch Q when the switch Q is “on.”

FIG. 2 shows an example power converter system 200 that is configured to supply and control electrical current to multiple output loads connected in series. The power converter system 200 may include output circuitry 203, which may include and/or be similar to the output circuitry 103, as described above with respect to FIG. 1. In addition, the power converter system 200 may include a power converter 202 that is configured to supply current to the output circuitry 203. The power converter 202 along with the output circuitry 203 may be configured to perform DC-to-DC power conversion, such as by converting an input voltage Vᵢₙ to a plurality of output voltages Vₒᵤₜ₁ to Vₒᵤₜ₂ across the output loads Z1 to Zn.

As a general topology, the power converter 202 may include charge/discharge circuitry 220 that is configured to discharge current to the output circuitry 203. The charge/discharge circuitry 220 may include storage circuitry 222 that is configured to store and discharge current. The storage circuitry 222 may include a single magnetic element or electronic storage component, such as an inductor or a transformer having primary and secondary windings. The storage circuitry 222 may be configured to receive and/or store current during a charge period of a switching cycle, and discharge at least some of the current during a discharge period of the switching cycle. In some example power converters 202, the charge period and the discharge period may be non-overlapping periods. When the power converter 202 is charging, the power converter 202 is not also discharging, and vice versa. As a result, the discharge periods may be discontinuous periods, such as discharge periods separated by periods of time where no current or substantially no current is being discharged. In other power converters 202, the charge period and the discharge period may be overlapping periods. During at least a portion of the charge period, the power converter 202 may also be discharging, and vice versa.

The charge/discharge circuitry 220 may also include main switching circuitry 224. The main switching circuitry 224 may control the charging and discharging of the storage circuitry 222. For example, the main switching circuitry 224 may be configured to switch between an “on” state and an “off” state. When the main switching circuitry 224 is in the “on” state, the storage circuitry 222 may be configured to receive and store the current. When the main switching circuitry is in the “off” state, the storage circuitry 222 may be configured to not receive and/or not store the current, and/or be configured to discharge the current. The main switching circuitry 224 may include one or more switches of various types, such as bipolar junction transistors (BJTs) or field-effect transistors (FETs), as examples. In addition, the main switching circuitry may 224 be configured to turn “on” and “off” by receiving one or more switching signals g₀. The switching signals g₀ may comprise one or more characteristics that determine whether the switch is turned “on” or turned “off” and/or for how long the switch is “on” or “off.” Example characteristics include waveform, amplitude, frequency, period, and duty cycle. In one example, the switching signals g₀ may comprise pulse-width modulated (PWM) signals having an associated duty cycle.

The charge/discharge circuitry 220 may be configured to receive an input signal, such as an input voltage signal Vᵢₙ from an input voltage source 226. In some examples, the input voltage Vᵢₙ may be a rectified AC voltage. For example, the input voltage Vᵢₙ may be a rectified version of an electrical supply from a wall outlet, such as a 120 V, 60 Hz voltage signal. In this way, the power converter 202 may be an off-line driver (e.g., an off-line LED driver) in that it may be directly connected to a 120 V AC source (or other power grid connection). The input voltage source 226 may include or be in communication with rectifier circuitry, such as a four-diode full-bridge rectifier, that rectifies the AC signal and communicates the rectified AC signal to the storage circuitry 224. The rectifier may be and/or may be part of power factor correction (PFC) circuitry that supplies the rectified AC signal to the storage circuitry 224. In some applications, such as those that include off-line drivers, a high power factor (e.g. in a range of about 0.9 to 1.0) may be preferred.

In other examples, the input voltage source 226 may be a DC voltage source that communicates a DC signal to the storage circuitry 222. In some examples, the DC source may provide changing, such as unpredictable or desirably changing, DC input signals. Based on receiving the input signal, the storage circuitry 224 may be configured to store the current. The stored current may be proportional to a magnitude of the input voltage signal.

FIG. 2 shows the input voltage source 226 as being part of the power converter 202. However, in alternative configurations, the input voltage source 226 may considered an external source to the power converter 202 that provides an input voltage to the power converter 202. Various configurations are possible.

The power converter 202 may have any of various converter topologies or configurations, such as buck, boost, buck-boost, flyback, single-ended primary-inductor (SEPIC), or Cuk, as examples. Other converter topologies are possible. In addition or alternatively, the power converter 202 may have a conversion ratio that is considered relatively small or narrow (e.g., less than or equal to one), or one that is considered relatively large or wide (e.g., greater than one). The flexibility for the power converter 202 to have either small or large conversion ratios may be attributable to the circuit segments 204 being connected in series as shown in FIG. 2, as opposed to alternative configurations that may configure or arrange the output loads Z in channels that are connected in parallel with each other. For these parallel configurations, power conversion may only be effective or optimal for power converters having wide-range conversion ratios, particularly where the output voltages Vₒᵤₜ₁ to Vₒᵤₜₙ vary or differ significantly.

The power converter system 200 may further include a controller 210 to communicate with the power converter 202 and the output circuitry 203 to control current generated and output by the power converter 202 and flow through the circuit segments 204 of the output circuitry 203. The controller 210 may be configured to turn each of the main switching circuitry 224 and the switches Q₂ to Qₙ “on” and “off” and/or maintain the main switching circuitry 224 and/or the switches Q₂ to Qₙ in “on” and/or “off” states. The controller 210 may be configured to generate and output a switching signal g₀ to the main switching circuitry 224 and switching signals g₂ to gₙ to the switches Q₂, to Qₙ to turn the main switching circuitry 224 and the switches Q₂ to Qₙ “on” and “off,” respectively.

In some example configurations, the controller 210 may include a signal generator 212 that is configured to generate the switching signals g₀ and g₂ to gₙ. The signal generator 212 may be implemented using hardware or a combination of hardware and software. The signal generator 212 may further be configured to determine and generate a particular type of switching signal. For example, the signal generator 212 may be configured to generate the switching signals g₀ and g₂ to gₙ as pulse-width modulated (PWM) switching signals, although other types of switching signals are possible. In some examples, the signal generator 212 may use or employ counting techniques to generate the switching signals g₀ and g₂ to gₙ. For example, the signal generator 212 may use or include one or more counters, such as up-counters and/or down-counters, to count between maximum and minimum values in resolution or step count intervals to generate the switching signals g₀ and g₂ to gₙ. Other techniques to generate the switching signals g₀ and g₂ to gₙ are possible.

The controller 210 may be configured to determine and set characteristics of the switching signals g₀ and g₂ to gₙ, such as waveform, amplitude, frequency, period, pulse width and/or duty cycle. These characteristics may be the same or different between the switching signals g₀ and g₂ to gₙ. In addition or alternatively, the controller 210 may be configured to determine when to send the switching signals g₀ and g₂ to gₙ to the main switching circuitry 224 and the switches Q₂ to Qn. Further, the controller 210 may be configured to determine when the main switching circuitry 224 and/or the switches Q₂ to Qₙ are to be “on” and “off,” which may affect when to send the switching signals g₀ and g₂ to gₙ. The controller 210 may further be configured to dynamically adjust or change any or at least some of the characteristics of the switching signals g₀ and g₂ to gₙ and/or when to output the switching signals g₀ and g₂ to gₙ. The controller 210 may make the determinations, settings, and/or adjustments individually or independently for each of the switching signals g₀ and g₂ to gₙ. For example, the controller 210 may determine to set or adjust the duty cycle of the switching signal g₀ independent of any determinations, settings, or adjustments of the switching signals g₂ to gₙ being applied to the switches Q₂ to Qₙ. As another example, the controller 210 may be configured to set or adjust a duty cycle of the switching signal g₂ being applied to the switch Q₂ independent of and/or without making an adjustment to a switching signal gₙ being applied to a different switch Qₙ. In alternative configurations, the determinations, settings, and/or adjustments may be made together or dependent on each other. Various configurations or combinations of configurations are possible.

The controller 210 may be configured to determine timing parameters, including charge periods, discharge periods, start times, stop times, and/or current ratios between the circuit segments 204, and/or other timing parameters to determine when to turn the main switching circuitry 224 and/or the switches Q₂ to Qₙ “on” and “off” and/or how long to maintain the main switching circuitry 224 and/or the switches Q₂, to Qₙ in “on” and “off” states. The charge periods may be time periods or time durations that the main switching circuitry 224 is “on.” The start time may be an operation time at which the main switching circuitry 224 and/or the switches Q₂ to Qₙ turn “on,” and the stop time may be a time at which the main switching circuitry 224 and/or the switches Q₂ to Qₙ turn “off.” Based on determining when and for how long to switch the main switching circuitry 224 and/or the switches Q₂ to Qₙ “on” and “off,” the controller 210 may determine the duty cycles of the switching signals g₀ and g₂ to gₙ and/or when to send the switching signals g₀ and g₂ to gₙ.

In addition or alternatively, the controller 210 may determine characteristics of the switching signals g₀ and g₂ to gₙ, time parameters, and/or when to turn the main switching circuitry 224 and/or the switches Q₂ to Qₙ “on” and “off” based on one or more switching or timing relationships between the main switching circuitry 224 and one or more of the output switches Q₂ to Qₙ. For example, the controller 210 may be configured to alternatingly turn the main switching circuitry 224 and at least one of the output switches Q₂ to Qₙ “on” and “off” and/or alternatingly maintain the main circuitry 224 and at least one of the output switches Q₂ to Qₙ in “on” and “off” states. In an alternative example, the controller 210 may be configured to turn the main switching circuitry 224 “on” and one or more of the switches Q₂ to Qₙ “on” concurrently and/or maintain the main switching circuitry 224 and one or more of the output switches Q₂ to Qₙ in “on” states concurrently. The switching or timing relationships may depend on whether the charge and discharge periods of the power converter 202 and the periods during which current flows through the output circuitry 203 are overlapping or non-overlapping.

The controller 210 may include a processor P, which may include a general processor, a digital signal processor, a microprocessor, a microcontroller, an application specific integrated circuit, a field programmable gate array, an analog circuit, a digital circuit, combinations thereof, or other now know known or later developed processors. In addition, the processor P may include a single processor, multiple processors, a single device or a combination of devices, such as associated with a network or distributed processing. Any of various processing strategies may be used, such as multi-processing, multi-tasking, parallel processing, remote processing, or the like. In addition or alternatively, the processor P may be responsive to and/or configured to execute instructions stored as part of software, hardware, integrated circuits, firmware, micro-code, or the like.

The controller may also include a memory M. The memory M may be a non-transitory computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media, and the like. The memory M may be a single device or a combination of devices. The memory M may be adjacent to, part of, networked with and/or removed from the processor P. Logic encoded in one or more tangible media for execution is defined as the instructions that are executable by the programmed processor P and that are provided on the computer-readable storage media, memories, or a combination thereof.

The memory M may be a computer readable storage media having stored therein data representing instructions executable by the programmed processor P. The memory M may store instructions for the processor P. The processor P may be programmed with and execute the instructions. The functions, acts, methods, or tasks illustrated in the figures or described herein are performed by the programmed processor P executing the instructions stored in the memory M. The functions, acts, methods or tasks are independent of the particular type of instructions set, storage media, processor or processing strategy and may be performed by software, hardware, integrated circuits, firmware, micro-code, and the like, operating alone or in combination. The instructions are for implementing the processes, techniques, methods, or acts described herein.

The memory M is shown in FIG. 2 as being a component of the controller 210. In alternative example configurations, the memory M may be a component that is separate from the controller 210. The controller 210 and/or one more components of the controller 210, such as the signal generator 212 and/or the processor P, may communicate with the memory M to perform their functions.

The signal generator 212 may be implemented with the processor P and/or the memory M to generate the switching signals g₀ and g₂ to gₙ. For example, the signal generator 212 may include or communicate with the processor P. In addition or alternatively, information and/or instructions used to generate the switching signals g₀ and g₂ to gₙ, such as the characteristics of the switching signals g₀ and g₂ to gₙ, the timing parameters, and/or information pertaining to when to output the switching signals g₀ and g₂ to g₀ may be stored in the memory M. Various configurations are possible.

In some example configurations, the controller 210 may include or be considered a single controller that generates and supplies switching signals to the main switching circuitry 224 and the switches Q₂ to Qₙ. In alternative example configurations, the controller 210 may include multiple controllers that generate and supply the switching signals. For example, one controller may be used to generate and/or supply switching signals to the switches Q₂ to Qₙ, and a second controller may be used to generate and/or supply a switching signal to the main switching circuitry 224. Alternatively, there may be a one-to-one correspondence between controllers and switches, where one controller may be used to generate and/or supply a switching signal to one switch. Various configurations that use a single controller or multiple controllers to generate and/or supply the switching signals are possible.

In some example configurations, the power converter system 200 may include a feedback system or feedback loop to monitor and/or measure the current being supplied to the output circuitry 203. The feedback system may include a sense resistor R_{S}, which may be placed in between a final circuit segment 204n and ground GND. The current passing through the output circuitry 203 may pass through the sense resistor R_{S}, which may generate a sense voltage V_{S} that is indicative of the current passing through the output circuitry 203. The sense voltage V_{S} may be fed back to the controller 210. Based on the received sense voltage V_{S}, the controller 210 may determine to adjust one or more characteristics of the switching signal g₀ being sent to the main switching circuitry 224, such as by comparing the sense voltage V_{S} with a reference voltage. For example, if sense voltage V_{S} is too low, such as by less than the reference voltage, the controller 210 may determine to increase the duty cycle of the switching signal g₀ proportionately to increase the amount of current being supplied by the power converter 202 to the output circuitry 203. Similarly, if the sense voltage V_{S} is too high, the controller 210 may determine to decrease the duty cycle of the switching signal g₀ proportionately to decrease the amount of current being supplied to the output circuitry 203.

Referring to FIG. 1, the bypass circuit paths 106, the switches Q, and the capacitors C are shown as being part of the circuit segments 104 making up the output circuitry 103. Alternatively, the bypass circuit paths 106 and/or the switches Q₂ to Qₙ may be considered electrical components of the circuit 100 that are separate from the circuit segments 104 and/or the output circuitry 103. For example, one or more of the bypass paths 106, the switches Q, or the capacitors C may be components of the circuit 100 connected in parallel with the output loads Z that are separate from the output circuitry 103.

Similarly, referring to FIG. 2, one or more of the bypass circuit paths 106, the switches Q, and/or the capacitors C may be considered components that are separate from the circuit segments 204 and/or the output circuitry 203. For example, the bypass circuit paths 106, the switches Q, and/or the capacitors C may be considered part of the converter 202, rather than the output circuitry 203. Alternatively, both the power converter 202 and the output circuitry 203 may be considered together as part of an overall power converter topology.

For some example configurations, the power converter system 200 may include some but not all of the components shown in FIG. 2. For example, the power converter system 200 may include the power converter 202 and the output circuitry 203, but not the controller 210. In still other configurations, the power converter system 200 may include all of the components shown in FIG. 2, except for the output loads Z or the parallel combination of the output loads Z and capacitors C. That is, the power converter system 200 may include electrical components to generate and supply electrical current to the output loads Z, but may not include the output loads Z themselves. In addition or alternatively, the output loads Z may be replaceable or interchangeable. For example, an LED included in an output load Z may become defective, and thereafter be replaced by a different LED. In still other example configurations, the power converter system 200 may include output circuitry 203 that may be configured to interface and/or be connected with multiple and/or different converters 202 or converter topologies. For example, the output circuitry 203 may be configured to interface with a boost converter and a flyback converter. A first power converter may be replaced with a second power converter to supply power to the output circuitry 203, such as if the first power converter becomes defective. Various configurations or combinations of configurations for the power converter system 200 are possible.

In some applications, the circuit 100 described with reference to and shown in FIG. 1 and/or the power converter system 200 described with reference to and shown in FIG. 2 may be used in lighting applications, such as light emitting diode (LED) lighting applications, where one or more of the output loads Z1 to Zn include LEDs.

FIG. 3 shows a circuit diagram of an example power converter system 300 that supplies current to a plurality of LEDs 330, 332 configured as output loads of circuit segments 304a, 304b. In alternative example configurations of the system 300, more circuit segments than the circuit segments 304a, 304b and/or more LEDs other than LEDs 330, 332 may be included. Each of the LEDs 330, 332 may include a single LED or a plurality of LEDs connected together in series, parallel, or a combination thereof. The LEDs 330, 332, each individually and/or in combination, may comprise an arrangement or a configuration, such as a red-green-blue (RGB) configuration or a blue-shifted yellow (BSY) plus red configuration, as examples. Each of the LEDs may correspond to and/or be associated with a part of the LED configuration. For example, the one or more LEDs 330 may be configured as BSY LEDs of a BSY plus red configuration, and the one or more LEDs 332 may be configured as red LEDs of the BSY plus red configuration. As another example, for a RGB configuration, each of the LEDs 330, 332 may correspond to at least one of a red LED, a green LED, or a red LED.

When current supplied by a power converter 302, which may be similar to the power converter 202 described with reference to FIG. 2, is drawn through the LEDs 330, 332, each LED may generate, output, and/or emit a light output. The light outputs emitted by the LEDs 330, 332 may combine and/or mix to produce a total or overall light output. The total or overall light output may be a predetermined and/or desired light output. The predetermined and/or desired light output may include a predetermined brightness and/or a color output or color point. The desired light output of the LEDs 330, 332 may be dependent upon the current being conducted through the LEDs 330, 332. As such, predetermined and/or desired amounts of current drawn through the LEDs 330, 332 may be determined in order to achieve the desired light output. The predetermined and/or desired amounts of current may depend on various factors, including a predetermined and/or desired color point or color output of the light output, a predetermined and/or desired brightness of the light output, one or more temperatures, such as operating temperatures, of the LEDs 330, 332, and/or lifetime expectancies of the LEDs.

The predetermined and/or desired amounts of current drawn may include a predetermined, total, and/or average current drawn over a time period, and/or proportions of the total or average current drawn for each of the output loads 330, 332. One or more ratios of the proportions of the total or average current drawn through the output loads 330, 332 may be determined. Further, where the desired light output may change, a change in the predetermined and/or desired currents drawn through the output loads 330, 332 may also be determined. The change in the predetermined and/or desired currents may include a change in the total or average current drawn over the time period and/or a change in the proportions or ratios of the total or average current drawn through the output loads 330, 332.

As an example illustration, the LEDs 330, 332 in the output circuitry 303 may be configured in a BSY plus red LED configuration. A desired or predetermined current ratio between the average current drawn through the BSY LEDs 330 and the average drawn through at least one red LED 332 may be determined to achieve a desired or predetermined light output. To change the light output (e.g., color and/or brightness) and/or to achieve a different desired or predetermined light output, the average current drawn through the red LED 332 may be changed, which in turn may change the average current ratio between the BSY LEDs 330 and the red LED 332. The average current drawn through the red LED 332 may be changed by changing the duty cycle of the switching signal g₂ being applied to the switch Q₂ (e.g., a MOSFET transistor) from a controller 310, which may be similar to the controller 210 (FIG. 2).

FIG. 4 shows an block diagram of an example lighting system 400 that may include a plurality or n-number of light sources 430a to 430n as output loads. Each of the light sources 430a to 430n may include one or more LEDs, such as the LEDs 330, 332 described above with reference to FIG. 3. Other light sources configured to generate a light output in response to electric current flow—such as organic LEDs (OLEDs), incandescent lights or gas discharge lights (e.g., fluorescent lights or neon lights), as examples—may be used as an alternative to or in combination with the LEDs.

A current source 402, which may be similar to the current source 102 or the power converter 202 described above with reference to FIGS. 1 and 2, may be configured to supply an electrical current to the light sources 430a to 430n to generate a light output. The current source 402 may be activated or powered by an input power source 426, which may be an AC voltage supplied from a power grid or wall output, as examples.

The light source 430a to 430n may be configured in circuit segments 404a to 404n, which may be similar to the circuit segments 104, 204, 304 described above with reference to FIGS. 1 to 3. At least one of the light sources 430n may be connected in parallel with a switch Qₙ, which may control whether current flows through to the light source 430n or is diverted away from flowing to the light source 430n. Switching of the switch between first and second states may be controlled by a controller 410, which may be similar to the controller 210 described above with reference to FIG. 2. A current ratio of the average or total current draw through the light sources 430a to 430n may be determined by switching of the switch Qₙ and/or a duty cycle of a switching signal gₙ being output by the controller 410 to switch the switch Qₙ. The current ratio may determine a light output generated by the light source 430a to 430n.

With reference to FIGS. 1-4, the circuit segments 104, 204, 304, 404 may be connected in series. In this way, the output loads Z may be connected in series when the switches Q in the bypass circuit paths are open or “off.” That is, for current flowing through the load Z1 (FIGS. 1 and 2), the current may also flow through the loads Z2 to Zn when their associated switches Q2 to Qn are “off.” By connecting the loads Z1 to Zn in series, rather than in parallel, power converters having relatively wide conversion ratios or relatively small conversion ratios may be used, as previously described. In addition, by connecting the loads Z1 to Zn in series, rather than in parallel, the components in the circuit segments 104, 204, 304, 404 including the switching components such as the switches Q and the diodes D, may be subjected to lower output voltages Vₒᵤₜ and/or reverse voltages. As a result, the switches Q and/or the diodes D may be subjected to lower voltage stress, increasing the lifetime of the components. Additionally, because the output voltages may be lower, as compared to parallel output load topologies, components with lower voltage ratings or “non-high” voltage ratings may be used, which may be generally lower in cost compared to “high rating” components, and thus may decrease production costs.

In addition, smaller-sized capacitors C may be used for configurations that connect the output loads Z in series, as opposed to configurations in which the output loads Z are connected in parallel. This may be because for parallel configurations, the capacitors C may be charged for relatively short time periods, and then supply energy to their associated loads Z. Conversely, for series configurations, the capacitors C may be charged relatively continuous, in which case energy storage requirements may be less, and the capacitors C may thus have smaller sizes.

In some example configurations, the frequency of the current through the circuit segments 104, 204, 304, 404 may be about twice the frequency of the input voltage. For example, where the input voltage is from a 60 Hz line voltage, then the frequency of the current flowing through the output frequency may be about 120 Hz. The double in frequency may be due to the input voltage and the input current being substantially in phase, such as for high PFC circuits. In other example configurations, the frequency of the current flowing through the circuit segments 104, 204, 304, 404 may be different than twice the frequency of the input voltage. Various configurations are possible.

In some situations, the current flowing through one or more of the circuit segments 104, 204, 304, 404 may have an undesirable ripple. For example, where two circuit segments are arranged in a BSY plus red LED configuration, the current flowing through the BSY LEDs may have a generally smooth sinusoidal waveform, whereas the current flowing through the red LED may have a sinusoidal waveform with ripples. To reduce the ripples, the frequency of the switching signal being applied to the switch in parallel with the red LED may be increased, which may result in shorter charging and discharging periods. In addition or alternatively, the capacitance of the capacitor in parallel with the red LED may be increased, which may cause the output voltage Vₒᵤₜ across the capacitor to vary less due to its increased ability to store energy.

FIG. 5 shows a flow chart of an example method 500 of conducting current through output circuitry having a plurality of output loads connected in series. At block 502, one or more duty cycles for one or more switching signals may be determined. The duty cycles may be determined for switching signals that are applied to switches included in bypass circuit paths to bypass current otherwise drawn through an output load. In addition, one of the duty cycles may be for a switching signal that is applied to switching circuitry included in a power converter.

The duty cycles may be determined based on a desired and/or predetermined amount of current drawn through the output loads. The duty cycle of a switching signal and the amount of current drawn through an associated output load may be inversely proportional. That is, an increase in a duty cycle may decrease the amount of current drawn through an output load, and vice versa. The amount of current desired or predetermined to be drawn through an output load may depend on a desired or predetermined current ratio of average current drawn between two output loads. In addition or alternatively, the amount of current may depend on a desired or predetermined output, such as a desired light output generated by one or more LEDs.

At block 504, the one or more switching signals may be generated with the determined duty cycles with a controller and/or signal generation circuitry included in and/or in communication with the controller. At block 506, the generated switching signals may be output to the associated switches to turn the switches “on” and “off.” At block 508, a current source, such as a power converter, may be activated and supply current to the output circuitry. The current supplied to the output circuitry may be an average amount of current over several cycles. At block 510, the electrical current may be received by the output circuitry and conducted through the output loads. Proportions of the average amount of current being conducted through at least one of the output loads may depend on the duty cycles determined at block 502. At block 512, one or more of the duty cycles may optionally be adjusted. One or more duty cycles may be adjusted to adjust the proportions of the average amount of current being conducted through the output loads. In some situations, the proportions may be adjusted to adjust the output generated by the output loads. In addition or alternatively, one or more duty cycles may be adjusted, such as in response to monitoring the output current through a feedback system, to adjust the duty cycle of the switching circuitry of the power converter.

In the method 500 described above, all or some of the actions may be performed concurrently or simultaneously. For example, the switches may receive switching signals and turn “on” and “off,” as described in block 506 while the power converter is supplying current to the output circuitry, as described in block 508. Various configurations are possible.

The foregoing detailed description has described only a few of the many possible implementations of the present invention. For this reason, this detailed description is intended by way of illustration, and not by way of limitation.

We claim:

1. A power converter system configured to supply current to a plurality of output loads, the power converter system comprising:
output circuitry comprising a first circuit segment and a second circuit segment, the first circuit segment electrically connected in series with the second circuit segment,
wherein the first circuit segment comprises a first output load, and
wherein the second circuit segment comprises a second output load connected in parallel with a switch, the switch configured to switch between a first state and a second state; and
a power converter configured to supply electrical current to the output circuitry to power the first and second output loads,
wherein the electrical current from the power converter bypasses the second output load and flows through the switch in response to the switch being in the first state.

2. The power converter system of claim 1, wherein the switch is configured to switch between the first state and the second state in response to receipt of a switching signal having an associated duty cycle, the duty cycle being set in accordance with a predetermined proportion of the supplied electrical current to be drawn through the second output load.

3. The power converter system of claim 2, wherein the predetermined proportion corresponds to a desired output produced by the second output load.

4. The power converter system of claim 2, wherein the predetermined proportion corresponds to a predetermined current ratio of average current drawn through the first output load and average current drawn through the second output load.

5. The power converter system of claim 4, wherein the predetermined current ratio corresponds to a predetermined output generated by the output circuitry.

6. The power converter system of claim 5, wherein the predetermined output comprises a predetermined light output.

7. The power converter system of claim 2, further comprising a controller configured to output the switching signal to the switch to turn the switch “on” in the first state and “off” in the second state.

8. The power converter system of claim 1, wherein the second circuit segment further comprises a capacitor connected in parallel with the second output load, and wherein the parallel connection of the second output load and the capacitor is connected in series with a reverse blocking diode.

9. The power converter system of claim 1, wherein the switch comprises a first switch,
wherein the first output load is connected in parallel with a second switch, the second switch configured to switch between the first state and the second state, wherein current flowing into the first circuit segment bypasses the first output load in response to the second switch being in the first state.

10. The power converter system of claim 1, wherein the switch comprises a first switch,
wherein the output circuitry further comprises a third circuit segment connected in series with the first circuit segment and the second circuit segment, and
wherein the third circuit segment comprises a third output load connected in parallel with a second switch, the second switch configured to switch between the first state and the second state, wherein current flowing into the third circuit segment bypasses the third output load in response to the second switch being in the first state.

11. The power converter system of claim 1, wherein at least one of the first output load or the second output load comprises a light emitting diode (LED).

12. The power converter system of claim 1, wherein the first output load and the second output load each comprise at least one light emitting diode (LED).

13. The power converter system of claim 12, wherein the at least one LED in the first output load and the at least one LED in the second output load are configured in a blue shift yellow (BSY) plus red LED configuration.

14. The power converter system of claim 13, wherein the at least one LED in the first output load comprises a plurality of BSY LEDs, and wherein the at least one LED in the second output load comprises at least one red LED.

15. The power converter system of claim 1, wherein the power converter comprises a boost converter.

16. The power converter system of claim 1, wherein the power converter comprises a buck converter.

17. The power converter system of claim 1, wherein the power converter comprises a buck-boost converter.

18. The power converter system of claim 1, wherein the power converter comprises a flyback converter.

19. A circuit configured to generate a plurality of power outputs, the circuit comprising:
output circuitry configured to receive current supplied from a single current source, the output circuitry comprising:
a first output load configured to generate a first power output, the first output load connected in parallel with a switch, the switch configured to switch between a first state and a second state; and
a second output load configured to generate a second power output, the second output load alternatingly connected in series with the first output load and the switch, the second output load being connected in series with the first output load in response to the switch being in the second state, the second output load being connected in series with the switch in response to the switch being in the first state.

20. The circuit of claim 19, wherein the single current source comprises a power converter.

21. The circuit of claim 19, wherein the switch is configured to switch between the first state and the second state in response to receipt of a switching signal having an associated duty cycle that is set in accordance with a predetermined current ratio of average current drawn through the first output load and average current drawn through the second output load.

22. The circuit of claim 21, wherein the predetermined current ratio corresponds to a predetermined output generated by the output circuitry, the output comprising the first power output and the second power output.

23. The circuit of claim 22, wherein the predetermined output comprises a predetermined light output.

24. The circuit of claim 19, wherein the switch is configured to receive a switching signal having a duty cycle that is inversely proportional to a proportion of the electrical current supplied by the single current source to flow through the first output load.

25. A method of conducting current through a plurality of output loads, the method comprising:
receiving, with output circuitry, an average amount of electrical current from a power converter, the output circuitry comprising a first circuit segment connected in series with a second circuit segment, the first circuit segment comprising a first output load, the second circuit segment comprising a second output load connected in parallel with a switch;
switching the switch between a first state and a second state with a switching signal having an associated duty cycle;
conducting a first proportion of the average amount of current through the first output load; and
conducting a second proportion of the average amount of current through the second output load,
wherein the second proportion of the average amount of current depends on the duty cycle of the switching signal.

26. The method of claim 25, wherein the first proportion of the average amount of current is substantially equal to the average amount of current received from the power converter.

27. The method of claim 25, further comprising:
determining, with a controller, the duty cycle of the switching signal based on a desired power output of the second output load.

28. The method of claim 25, further comprising:
determining, with a controller, the duty cycle of the switching signal based on a desired output of the output circuitry.

29. The method of claim 28, wherein the desired output comprises a desired light output.

30. The method of claim 25, further comprising:
determining, with a controller, the duty cycle of the switching signal based on a predetermined current ratio of the first proportion of the average amount of current and the second proportion of the average amount of current.

31. The method of claim 25, further comprising:
adjusting, with a controller, the duty cycle of the switching signal to adjust the second proportion of the average amount of current being conducted through the second output load.

32. The method of claim 25, wherein at least one of the first output load or the second output load comprises a light emitting diode (LED).

33. The method of claim 25, wherein the first output load and the second output load each comprise at least one light emitting diode (LED).

34. The method of claim 33, wherein the at least one LED in the first output load and the at least one LED in the second output load are configured in a blue shift yellow (BSY) plus red LED configuration.

35. The method of claim 34, wherein the at least one LED in the first output load comprises a plurality of BSY LEDs, and wherein the at least one LED in the second output load comprises at least one red LED.

36. The method of claim 25, wherein the power converter comprises a boost converter.

37. The method of claim 25, wherein the power converter comprises a buck converter.

38. The method of claim 25, wherein the power converter comprises a buck-boost converter.

39. The method of claim 25, wherein the power converter comprises a flyback converter.
